(19) United States
(12) Patent Application Publication
(10) Pub. No.: US 2026/0164202 A1
(43) Pub. Date: Jun. 11, 2026

(54) METHOD AND SYSTEM FOR REPLICATING HEADPHONE SOUND USING FRONTAL AND SUPPLEMENTARY SPEAKERS

(71) Applicant: Creative Technology Ltd, Singapore (SG)

(72) Inventor: Kok Huan Ong, Singapore (SG)

(73) Assignee: Creative Technology Ltd, Singapore (SG)

(21) Appl. No.: 19/410,118

(22) Filed: Dec. 5, 2025

Related U.S. Application Data
(60) Provisional application No. 63/728,925, filed on Dec. 6, 2024.

(51) Int. Cl. H04S 7/00; H04R 5/02; H04R 29/00

(52) U.S. Cl. CPC H04S 7/30; H04R 5/02; H04R 29/001

(57) ABSTRACT

A method for replicating headphone sound using frontal and supplementary speakers in an audio system. The method includes positioning a pair of frontal stereo speakers and a pair of supplementary speakers near a user's ears in a predetermined configuration, adding delay to either the pair of frontal speakers or the pair of supplementary speakers, playing test audio signals through the pair of frontal stereo speakers and supplementary speakers, measuring interaural level differences (ILD) at the user's ears across a frequency range of about 1 kHz to about 10 kHz to obtain a measured ILD, comparing the measured ILD to a generic ILD that represents a headphone-like spatial audio effect, deriving a set of equalization (EQ) settings for the pair of supplementary speakers to reduce differences between the measured ILD and the generic ILD, and storing the set of EQ settings for use in the audio system.

### CROSS-REFERENCE TO RELATED APPLICATIONS

This application claims priority to and the benefit of U.S. Provisional Patent Application No. 63/728,925 filed Dec. 6, 2024 and entitled “METHOD AND SYSTEM FOR REPLICATING HEADPHONE SOUND USING FRONTAL AND SUPPLEMENTARY SPEAKERS,” which is incorporated herein by reference in its entirety for all purposes.

### TECHNICAL FIELD

The present disclosure generally relates to audio systems, and more particularly relates to an audio system with frontal and near-ear speakers for replicating a headphone-like experience through HRTF-based EQ adjustments.

### BACKGROUND

Audio systems traditionally fall into two primary categories: open-air speaker setups and personal listening devices such as headphones. Each has its own advantages and limitations. Headphones are popular for their ability to deliver a private, immersive sound experience, often achieving this through head-related transfer functions (HRTFs) that simulate a spatial audio environment tailored to each listener. However, prolonged headphone use can lead to discomfort, ear fatigue, and social isolation, as the listener is largely cut off from external sounds.

On the other hand, speaker systems provide an open listening environment that allows users to stay aware of their surroundings and listen comfortably over long periods. Yet, speakers often lack the intimacy and precise spatial cues found in headphones, making it challenging to achieve the same level of audio immersion for movie and music content, as well as the precise sound localization necessary for gaming purposes. Typical speaker setups struggle to replicate the directional sound localization effects that headphones provide, due in part to the absence of individualized HRTF processing.

Efforts to bridge the gap between speaker systems and headphone experiences have led to technologies such as, for example, surround sound and near-field monitors. While these provide enhanced spatial audio compared to conventional speakers, they still fall short of delivering the headphone-like, immersive soundstage that many listeners seek. Thus, there remains a desire for an audio system that combines the comfort and openness of speakers with the personalized, spatially immersive qualities of headphones, offering listeners a more engaging and realistic audio experience without the drawbacks associated with prolonged headphone use.

### SUMMARY

In various embodiments, a method for replicating headphone sound using frontal and supplementary speakers in an audio system is provided. The method includes positioning a pair of frontal stereo speakers and a pair of supplementary speakers near a user's ears in a predetermined configuration, adding delay to either the pair of frontal speakers or the pair of supplementary speakers, playing test audio signals through the pair of frontal stereo speakers and the pair of supplementary speakers, measuring interaural level differences (ILD) at the user's ears position across a frequency range of 1 kHz to 10 kHz to obtain a measured ILD, comparing the measured ILD to a generic ILD that represents a headphone-like spatial audio effect, deriving a set of equalization (EQ) settings for the pair of supplementary speakers to reduce differences between the measured ILD and the generic ILD, and storing the set of EQ settings for use in the audio system.

In various embodiments, an audio system for replicating headphone sound using frontal and supplementary speakers is provided. The audio system includes a pair of frontal stereo speakers and a pair of supplementary speakers configured for placement near a user's ears, a delay module configured to add delay to either the pair of frontal stereo speakers or the pair of supplementary speakers, a storage module configured to store a set of pre-calibrated equalization (EQ) settings, and an audio processing module configured to apply the set of pre-calibrated EQ settings to the pair of supplementary speakers. The set of pre-calibrated EQ settings is derived from a comparison of measured interaural level differences (ILD) of the audio system with a generic ILD and pre-calibrated to reduce differences between the measured ILD and the generic ILD.

### BRIEF DESCRIPTION OF THE DRAWINGS

The features and advantages of the present disclosure will become more apparent from the detailed description set forth below when taken in conjunction with the drawings.

FIG. 1 is a flow diagram depicting an exemplary method of replicating headphone sound using frontal and supplementary speakers, in accordance with various embodiments.

FIG. 2 is a graphical representation of Interaural Level Difference as a function of frequency, in accordance with various embodiments.

FIG. 3 is a system diagram of an exemplary audio system for replicating headphone sound using frontal and supplementary speakers, in accordance with various embodiments.

FIG. 4 is a system diagram of an exemplary audio system for replicating headphone sound using frontal and supplementary speakers, in accordance with various embodiments.

### DETAILED DESCRIPTION

The following detailed description is merely exemplary in nature and is not intended to limit the disclosure or the application and uses of the disclosure. Furthermore, there is no intention to be bound by any theory presented in the preceding background of the disclosure or the following detailed description. It is an intent of the various embodiments to present a method and system for replicating headphone sound using frontal and supplementary speakers to replicate the advantages of headphones without their associated discomfort and other issues.

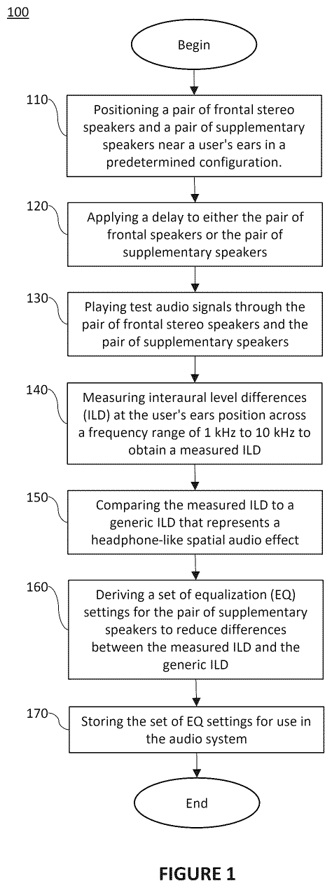

Referring to FIG. 1, a flow diagram (100) depicting an exemplary method of replicating headphone sound using frontal and supplementary speakers in accordance with various embodiments is shown. In step 110, a pair of frontal stereo speakers and a pair of supplementary speakers are positioned near a user's ears in a predetermined configuration. The pair of frontal stereo speakers are located in front of the user, positioned to face the user directly. These speakers are preferably designed as a soundbar and are ideally placed in the near-field, at a distance of approximately 100 cm to 140 cm from the user. The pair of supplementary speakers are near-ear, and can be implemented in various forms, such as neck-worn speakers, neckband speakers, headband speakers, chair speakers, spectacle frames, or head worn apparel (e.g., caps, hats or beanies). To enhance comfort, low-frequency components of the audio output are removed from the pair of supplementary speakers to avoid uncomfortable vibrations on the user's body. This is preferably achieved using a high-pass filter. Preferably, the high-pass filter removes frequencies below 300 Hz.

In step 120, a delay is applied to either the pair of frontal stereo speakers or the pair of supplementary speakers to synchronize the audio arrival times at the user's ears. The goal is to ensure that the time taken for sound to travel from both sets of speakers to the user's ears is nearly identical, allowing a tolerance of up to 0.5 ms. The implementation of the delay depends on the connection type of the pair of supplementary speakers and/or the connection type of the pair of frontal stereo speakers to the audio system. The pair of supplementary speakers and/or the pair of frontal stereo speakers can be connected to the audio system by a cable or wirelessly. The delay can be determined by calculating a difference in time taken for sound to travel from both sets of speakers to the user's ears. The delay is applied to the pair of supplementary speakers if the time taken for sound to travel from the pair of frontal stereo speakers to the user's ears is longer than the time taken for sound to travel from the pair of supplementary speakers to the user's ears. The delay is applied to the pair of frontal stereo speakers if the time taken for sound to travel from the pair of supplementary speakers to the user's ears is longer than the time taken for sound to travel from the pair of frontal stereo speakers to the user's ears. The time it takes for sound to travel from the pair of frontal stereo speakers and the pair of supplementary speakers to the user's ears is influenced by the physical distance of the speakers from the user, as well as any wireless transmission latency. For instance, Bluetooth 5.4 with the LC3 codec typically introduces a latency of 20-40 ms, while Bluetooth aptX Low Latency has a latency of approximately 30-40 ms. Actual latency may also vary depending on the manufacturer's implementation. In one embodiment, the delay can be determined by measurement. A test audio signal is played through the pair of frontal stereo speakers, and a first time taken for test audio signal to arrive at the user's ears is measured. A test audio signal is played through the pair of supplementary speakers, and a second time taken for test audio signal to arrive at the user's ears is measured. For example, measurement can be done using a head and torso simulator or a binaural microphone. The delay is then determined by calculating the difference in the first time taken and the second time taken. The delay is applied to the pair of supplementary speakers if the first time taken is longer than the second time taken, and applied to the pair of stereo frontal speakers if the second time taken is longer than the first time taken. This method of determining delay by measurement takes into account both the physical distance of the speakers from the user, as well as any transmission latencies. In one embodiment, the delay can be determined by calculation. A first time taken for sound waves to arrive at the user's ears from the pair of frontal stereo speakers is calculated based on the physical distance of the pair of frontal stereo speakers to the user's ears and the speed of sound, as well as any wireless latency delay time if the pair of frontal stereo speakers is connected to the audio system wirelessly. A second time taken for sound waves to arrive at the user's ears from the pair of supplementary speakers is calculated based on the physical distance of the pair of supplementary speakers to the user's ears and the speed of sound, as well as any wireless latency delay time if the pair of supplementary speakers is connected to the audio system wirelessly. The delay is determined by calculating the difference in the first time taken and the second time taken. The delay is applied to the pair of supplementary speakers if the first time taken is longer than the second time taken, and applied to the pair of stereo frontal speakers if the second time taken is longer than the first time taken. Generally, the pair of frontal stereo speakers can be assumed to be at about 100 cm to 140 cm away from the user's ears. The difference in the time taken for the sound waves to arrive at the user's ears can also be determined by first calculating the difference in physical distance of the pair of frontal stereo speakers to the user's ears and the pair of supplementary speakers to the user's ears, thereafter calculating the time difference by using the speed of sound, then factoring in the wireless latencies, if any. In one example, the pair of frontal stereo speakers is connected by cable to the audio system, while the pair of supplementary speakers is connected to the audio system wirelessly by Bluetooth LE Audio in broadcast mode with latency of 20 ms. The distance of the pair of frontal stereo speakers to the user's ear is 120 cm (midpoint of 100 cm to 140 cm). The distance of the pair of supplementary speakers to the user's ear is 20 cm. Speed of sound is taken to be 343 m/s. By calculation, the difference in physical distance of 100 cm necessitates a delay of around 3 ms (to be applied to the pair of supplementary speakers). Accounting for the 20 ms wireless latency, which necessitates a delay of 20 ms to be applied to the pair of frontal stereo speakers, a delay of 17 ms is applied to the pair of frontal stereo speakers in this example.

In step 130, test audio signals are played through the pair of frontal stereo speakers and the pair of supplementary speakers, and the interaural level differences (ILD) at the user's ears position across a frequency range of 1 kHz to 10 kHz is measured to obtain a measured ILD in step 140. The ILD can, for example, be measured at the user's ears position by using a head and torso simulator, or a binaural microphone. The measured ILD is compared to a generic ILD that represents a headphone-like spatial audio effect in step 150, and a set of equalization (EQ) settings for the pair of supplementary speakers to reduce differences between the measured ILD and the generic ILD is derived in step 160. The EQ settings are derived by adjusting the EQ settings to achieve a measured ILD that differs from the generic ILD by no more than a pre-determined threshold of around ±5 dB across a specified frequency range, such as 1 kHz to 10 kHz. The generic ILD can be obtained by positioning a pair of reference stereo speakers directed to the user's ears, playing test audio signals through the pair of reference stereo speakers, and measuring ILD at the user's ears position across a frequency range of 1 kHz to 10 kHz to obtain the generic ILD. The generic ILD can also be obtained from a generic database such as the CIPIC HRTF Database, ARI HRTF Database, Spatially Oriented Format for Acoustics (SOFA), MIT KEMAR HRTF Database and OpenSL HRTF Database by extracting the ILD from the HRTF data.

In step 170, the set of EQ settings is stored (and/or saved) for use in the audio system. By applying delay and equalization (EQ) adjustments, the audio system replicates the experience of headphone sound during playback, utilizing the pair of frontal stereo speakers and the pair of supplementary speakers. Advantageously, the audio system necessitates less computationally intensive processing methods such as delay and equalization (EQ) adjustments to achieve a headphone-like sound experience, eliminating the more complex and computationally intensive processing methods such as binaural rendering or real-time HRTF manipulation. By focusing on aligning the time of arrival of sound through simple delay adjustments and refining the spectral balance via pre-calibrated EQ settings, the system efficiently replicates the interaural cues necessary for spatial audio perception. This streamlined approach minimizes the use of hardware and/or software, reduces latency, and ensures compatibility with various form factors for the pair of supplementary speakers, all while maintaining high-quality audio output. Advantageously, the audio system is designed to work with a standard stereo audio source, without relying on specialized multi-channel audio formats. This simplifies integration with a wide range of audio devices and content, as stereo is the most commonly available audio format across media platforms. By leveraging delay and equalization adjustments, the system effectively creates a spatial audio experience without requiring complex surround sound encoding or decoding, making it more accessible, cost-effective, and universally compatible with existing audio sources.

Although the steps in the flow diagrams are given sequentially, it should be appreciated that some of the steps can be performed concurrently, or in a different sequence. The steps described may be implemented in hardware, software, firmware, or any combination thereof.

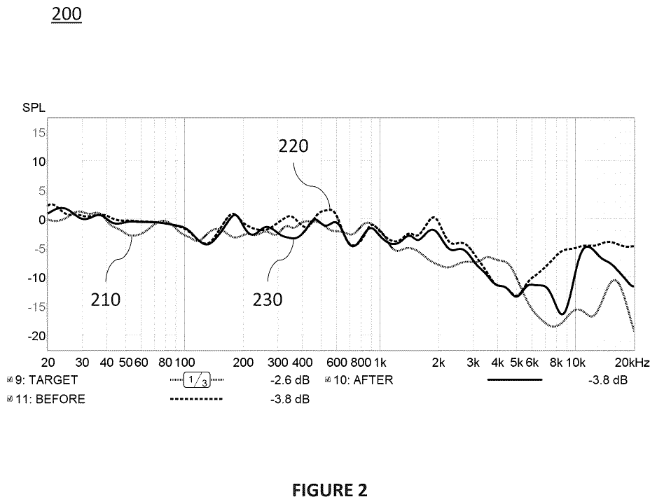

Referring to FIG. 2, a graphical representation (200) of Interaural Level Difference (ILD) as a function of frequency in accordance with various embodiments is shown. The generic ILD is shown in line 210. The measured ILD is shown in line 220. After the set of EQ settings is derived and applied, the final ILD is shown in line 230. The differences can mainly be observed at the 1 kHz to 10 kHz range, where the final ILD is more similar to the generic ILD after the set of derived EQ settings is applied. It can be seen that the measured ILD differs from the generic ILD by no more than a pre-determined threshold of around 5 dB across the 1 kHz to 10 kHz frequency range.

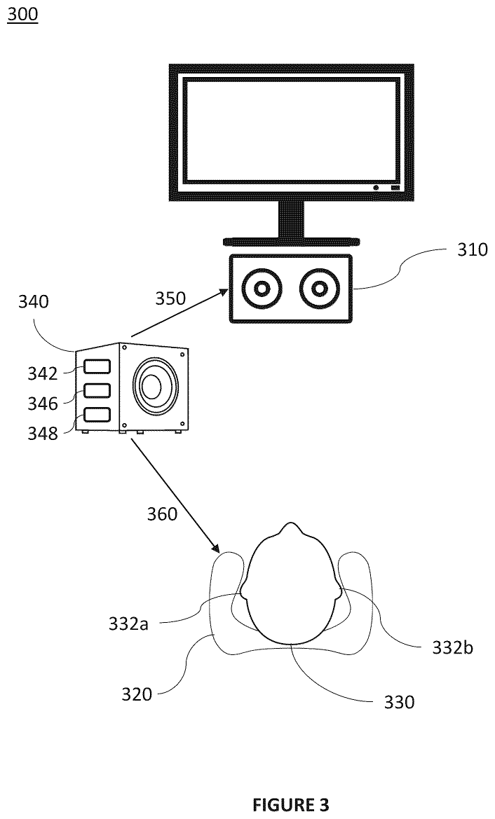

Referring to FIG. 3, a system diagram of an audio system (300) for replicating headphone sound using frontal (310) and supplementary speakers (320) in accordance with various embodiments is shown. The audio system (300) includes a pair of frontal stereo speakers (310) and a pair of supplementary speakers (320) configured for placement near a user's (330) ears (332a, 332b). In one embodiment, the audio system (300) may include a subwoofer (340) or an audio hub (not shown), connected to the pair of frontal stereo speakers (310) and the pair of supplementary speakers (320) via cable or wirelessly (350, 360). The audio system (300) includes a delay module (342) configured to apply a delay to either the pair of frontal stereo speakers (310) or the pair of supplementary speakers (320). The audio system (300) also includes a storage module (346) and an audio processing module (348). The storage module (346) is configured to store a set of pre-calibrated equalization (EQ) settings, and the audio processing module (348) is configured to apply the set of pre-calibrated EQ settings to the pair of supplementary speakers (320). The set of pre-calibrated EQ settings is derived from a comparison of measured interaural level differences (ILD) of the audio system (300) with a generic ILD and pre-calibrated to reduce differences between the measured ILD and the generic ILD, as earlier detailed in FIG. 2. The delay module (342) can alternatively be located within the pair of frontal stereo speakers (310) or the pair of supplementary speakers (320). The storage module (346) and the audio processing module (348) can alternatively be located within the pair of supplementary speakers (320).

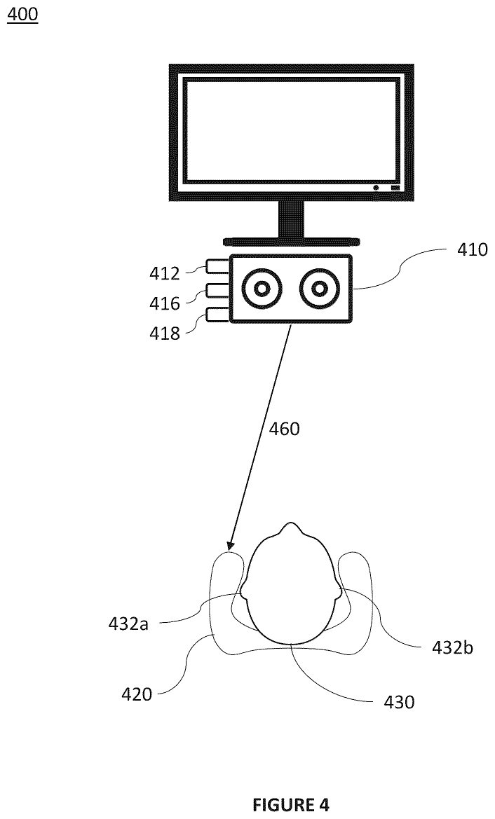

Referring to FIG. 4, a system diagram of an audio system (400) for replicating headphone sound using frontal (410) and supplementary speakers (420) in accordance with various embodiments is shown. The audio system (400) includes a pair of frontal stereo speakers (410) and a pair of supplementary speakers (420) configured for placement near a user's (430) ears (432a, 432b). In one embodiment, the audio system (400) may include the pair of frontal stereo speakers (410) and the pair of supplementary speakers (420), with the pair of frontal stereo speakers (410) serving as the audio hub and the pair of supplementary speakers (420) connected via cable or wirelessly (460) to the pair of frontal stereo speakers (410). The audio system (400) includes a delay module (412) configured to apply a delay to either the pair of frontal stereo speakers (410) or the pair of supplementary speakers (420). The audio system (400) also includes a storage module (416) and an audio processing module (418). The storage module (416) is configured to store a set of pre-calibrated equalization (EQ) settings, and the audio processing module (418) is configured to apply the set of pre-calibrated EQ settings to the pair of supplementary speakers (420). The set of pre-calibrated EQ settings is derived from a comparison of measured interaural level differences (ILD) of the audio system (400) with a generic ILD and pre-calibrated to reduce differences between the measured ILD and the generic ILD, as earlier detailed in FIG. 2. The delay module (412) can alternatively be located within the pair of supplementary speakers (420), especially when the delay is applied to the pair of supplementary speakers (420). The storage module (416) and the audio processing module (418) can be located within the pair of supplementary speakers (420) instead of the pair of frontal stereo speakers (410).

In the audio system (300, 400), the pair of frontal stereo speakers (310, 410) are located in front of the user (330, 430), positioned to face the user (330, 430) directly. These speakers (310, 410) are preferably designed as a soundbar and are ideally placed in the near-field, at a distance of approximately 100 cm to 140 cm from the user (330, 430). The pair of supplementary speakers (320, 420) are near-ear, and can be implemented in various forms, such as neck-worn speakers, neckband speakers, headband speakers, chair speakers, spectacle frames, or head worn apparel (e.g., caps, hats or beanies). To enhance comfort, low-frequency components of the audio output are removed from the pair of supplementary speakers (320, 420) to avoid uncomfortable vibrations on the user's body. This is preferably achieved using a high-pass filter. Preferably, the high-pass filter removes frequencies below 300 Hz.

Delay module (342, 412) applies a delay to either the pair of frontal stereo speakers (310, 410) or the pair of supplementary speakers (320, 420) to synchronize the audio arrival times at the user's ears (332a/b, 432a/b). The goal is to ensure that the time taken for sound to travel from both sets of speakers to the user's ears (332a/b, 432a/b) is nearly identical, allowing a tolerance of up to ±0.5 ms. The implementation of the delay depends on the connection type of the pair of supplementary speakers (320, 420) and/or the connection type of the pair of frontal stereo speakers (310, 410). The pair of supplementary speakers (320, 420) and/or the pair of frontal stereo speakers (310, 410) can be connected to the audio system (300, 400) by a cable or wirelessly. The delay can be determined by calculating a difference in time taken for sound to travel from both sets of speakers to the user's ears (332a/b, 432a/b). The delay is applied to the pair of supplementary speakers (320, 420) if the time taken for sound to travel from the pair of frontal stereo speakers (310, 410) to the user's ears (332a/b, 432a/b) is longer than the time taken for sound to travel from the pair of supplementary speakers (320, 420) to the user's ears (332a/b, 432a/b). The delay is applied to the pair of frontal stereo speakers (310, 410) if the time taken for sound to travel from the pair of supplementary speakers (320, 420) to the user's ears (332a/b, 432a/b) is longer than the time taken for sound to travel from the pair of frontal stereo speakers (310, 410) to the user's ears (332a/b, 432a/b). The time it takes for sound to travel from the pair of frontal stereo speakers (310, 410) and the pair of supplementary speakers (320, 420) to the user's ears (332a/b, 432a/b) is influenced by the physical distance of the speakers from the user (330, 430), as well as any wireless transmission latency. For instance, Bluetooth 5.4 with the LC3 codec typically introduces a latency of 20-40 ms, while Bluetooth aptX Low Latency has a latency of approximately 30-40 ms. Actual latency may also vary depending on the manufacturer's implementation. In one embodiment, the delay can be determined by measurement with a delay measurement module. A test audio signal is played through the pair of frontal stereo speakers (310, 410), and a first time taken for test audio signal to arrive at the user's ears (332a/b, 432a/b) is measured. A test audio signal is played through the pair of supplementary speakers (320, 420), and a second time taken for test audio signal to arrive at the user's ears (332a/b, 432a/b) is measured. For example, measurement can be done using a head and torso simulator or a binaural microphone. The delay is then determined by calculating the difference in the first time taken and the second time taken. The delay is applied to the pair of supplementary speakers (320, 420) if the first time taken is longer than the second time taken, and applied to the pair of stereo frontal speakers (310, 410) if the second time taken is longer than the first time taken. This method of determining delay by measurement takes into account both the physical distance of the speakers from the user (330, 430), as well as any transmission latencies. In one embodiment, the delay can be determined by calculation with a delay calculation module, or pre-calculated during product design stage. A first time taken for sound waves to arrive at the user's ears (332a/b, 432a/b) from the pair of frontal stereo speakers (310, 410) is calculated based on the physical distance of the pair of frontal stereo speakers (310, 410) to the user's ears (332a/b, 432a/b) and the speed of sound, as well as any wireless latency delay time if the pair of frontal stereo speakers (310, 410) is connected to the audio system (300, 400) wirelessly. A second time taken for sound waves to arrive at the user's ears (332a/b, 432a/b) from the pair of supplementary speakers (320, 420) is calculated based on the physical distance of the pair of supplementary speakers (320, 420) to the user's ears (332a/b, 432a/b) and the speed of sound, as well as any wireless latency delay time if the pair of supplementary speakers (320, 420) is connected to the audio system (300, 400) wirelessly. The delay is determined by calculating the difference in the first time taken and the second time taken. The delay is applied to the pair of supplementary speakers (320, 420) if the first time taken is longer than the second time taken, and applied to the pair of stereo frontal speakers (310, 410) if the second time taken is longer than the first time taken. Generally, the pair of frontal stereo speakers (310, 410) can be assumed to be at about 100 cm to 140 cm away from the user's ears (332a/b, 432a/b). The difference in the time taken for the sound waves to arrive at the user's ears (332a/b, 432a/b) can also be determined by first calculating the difference in physical distance of the pair of frontal stereo speakers (310, 410) to the user's ears (332a/b, 432a/b) and the pair of supplementary speakers (320, 420) to the user's ears (332a/b, 432a/b), thereafter calculating the time difference by using the speed of sound, then factoring in the wireless latencies, if any. In one example, the pair of frontal stereo speakers (310) is connected by cable (350) to the audio system (300), while the pair of supplementary speakers (320) is connected to the audio system wirelessly (360) by Bluetooth LE Audio in broadcast mode with latency of 20 ms. The distance of the pair of frontal stereo speakers (310) to the user's ear (332a/b) is 120 cm (midpoint of 100 cm to 140 cm). The distance of the pair of supplementary speakers (320) to the user's ear (332a/b) is 20 cm. Speed of sound is taken to be 343 m/s. By calculation, the difference in physical distance of 100 cm necessitates a delay of around 3 ms to be applied to the pair of supplementary speakers (320). Accounting for the 20 ms wireless latency, which necessitates a delay of 20 ms to be applied to the pair of frontal stereo speakers (310), a delay of 17 ms is applied to the pair of frontal stereo speakers (310) in this example.

A set of pre-calibrated equalization (EQ) settings is stored (or saved) in the storage module (346, 416). The set of pre-calibrated EQ settings is derived from a comparison of measured interaural level differences (ILD) of the audio system with a generic ILD and pre-calibrated to reduce differences between the measured ILD and the generic ILD.

Test audio signals are played through the pair of frontal stereo speakers (310, 410) and the pair of supplementary speakers (320, 420), and the interaural level differences (ILD) at the user's ears (332a/b, 432a/b) position across a frequency range of 1 kHz to 10 kHz is measured to obtain a measured ILD. The ILD can, for example, be measured at the user's ears (332a/b, 432a/b) position by using a head and torso simulator, or a binaural microphone. The measured ILD is compared to a generic ILD that represents a headphone-like spatial audio effect, and a set of equalization (EQ) settings for the pair of supplementary speakers (320, 420) to reduce differences between the measured ILD and the generic ILD is derived. The EQ settings are derived by adjusting the EQ settings to achieve a measured ILD that differs from the generic ILD by no more than a pre-determined threshold of around ±5 dB across a specified frequency range, such as 1 kHz to 10 kHz. The generic ILD can be obtained by positioning a pair of reference stereo speakers directed to the user's ears (332a/b, 432a/b), playing test audio signals through the pair of reference stereo speakers, and measuring ILD at the user's ears (332a/b, 432a/b) position across a frequency range of 1 kHz to 10 kHz to obtain the generic ILD. The generic ILD can also be obtained from a generic database such as the CIPIC HRTF Database, ARI HRTF Database, Spatially Oriented Format for Acoustics (SOFA), MIT KEMAR HRTF Database and OpenSL HRTF Database by extracting the ILD from the HRTF data.

The audio processing module (348, 418) is configured to apply the set of pre-calibrated EQ settings stored in the storage module (346, 416) to the pair of supplementary speakers (320, 420). By applying delay and equalization (EQ) adjustments, the audio system replicates the experience of headphone sound during playback, utilizing the pair of frontal stereo speakers (310, 410) and the pair of supplementary speakers (320, 420). Advantageously, the audio system necessitates less computationally intensive processing methods such as delay and equalization (EQ) adjustments to achieve a headphone-like sound experience, eliminating more complex and computationally intensive processing methods such as binaural rendering or real-time HRTF manipulation. By focusing on aligning the time of arrival of sound through simple delay adjustments and refining the spectral balance via pre-calibrated EQ settings, the system efficiently replicates the interaural cues necessary for spatial audio perception. This streamlined approach minimizes the use of hardware and/or software, reduces latency, and ensures compatibility with various form factors for the pair of supplementary speakers, all while maintaining high-quality audio output. Advantageously, the audio system is designed to work with a standard stereo audio source, without relying on specialized multi-channel audio formats. This simplifies integration with a wide range of audio devices and content, as stereo is the most commonly available audio format across media platforms. By leveraging delay and equalization adjustments, the system effectively creates a spatial audio experience without requiring complex surround sound encoding or decoding, making it more accessible, cost-effective, and universally compatible with existing audio sources.

The innovative aspect of this disclosure lies in the application of binaural techniques within a speaker system rather than relying solely on headphone-based designs. The use of binaural techniques, combined with the strategic placement of rear speakers, ensures a superior audio experience by maintaining the integrity of spatial cues and providing an immersive sound field.

Enhanced Spatial Accuracy for Gaming: Many gaming audio designs are optimized for headphone playback. This system's ability to emulate headphone sound fields allows gamers to experience spatially accurate audio, potentially improving performance.

Comfort: Unlike headphones, the near-ear speakers provide a comfortable listening experience suitable for extended use.

By addressing the desire for spatially accurate, comfortable audio solutions, this disclosure provides a significant advancement in the field of immersive audio systems, particularly for gaming and multimedia applications.

Thus, it can be seen that a method and system for replicating headphone sound using frontal and supplementary speakers to replicate the advantages of headphones without their associated discomfort and localization has been provided.

While exemplary embodiments have been presented in the foregoing detailed description of the present embodiments, it should be appreciated that a vast number of variations exists. It should further be appreciated that the exemplary embodiments are only examples, and are not intended to limit the scope, applicability, operation, or configuration of the disclosure in any way. Rather, the foregoing detailed description will provide those skilled in the art with a convenient road map for implementing exemplary embodiments of the disclosure, it being understood that various changes may be made in the function and arrangement of steps and method of operation described in the exemplary embodiments without departing from the scope of the disclosure as set forth in the appended claims.

1. A method for replicating headphone sound using a pair of frontal stereo speakers and a pair of supplementary speakers in an audio system, the method comprising:
positioning the pair of frontal stereo speakers and the pair of the supplementary speakers near a user's ears in a predetermined configuration;
applying a delay to either the pair of frontal stereo speakers or the pair of supplementary speakers;
playing test audio signals through the pair of frontal stereo speakers and the pair of supplementary speakers;
measuring interaural level differences (ILD) at the user's ears across a frequency range of about 1 kHz to about 10 kHz to obtain a measured ILD;
comparing the measured ILD to a generic ILD that represents a headphone-like spatial audio effect;
deriving a set of equalization (EQ) settings for the pair of supplementary speakers to reduce differences between the measured ILD and the generic ILD; and
storing the set of EQ settings for use in the audio system.

2. The method of claim 1, wherein the measuring ILD at the user's ears is carried out using a head and torso simulator or a binaural microphone.

3. The method of claim 1, wherein the applying a delay to either the pair of frontal stereo speakers or the pair of supplementary speakers further comprises:
playing test audio signal through the pair of frontal stereo speakers;
measuring a first time for a test audio signal to arrive at the user's ears;
playing the test audio signal through the pair of supplementary speakers;
measuring a second time for the test audio signal to arrive at the user's ears;
determining the delay by calculating a difference in the first time and the second time;
applying the delay to the pair of supplementary speakers, in response to the first time being longer than the second time, and
applying the delay to the pair of stereo frontal speakers, in response to the second time being longer than the first time.

4. The method of claim 1, wherein the applying a delay to either the pair of frontal stereo speakers or the pair of supplementary speakers further comprises:
calculating a first time for sound waves to arrive at the user's ears from the pair of frontal stereo speakers;
calculating a second time for sound waves to arrive at the user's ears from the pair of supplementary speakers;
determining the delay by calculating a difference in the first time and the second time, and
applying the delay to the pair of supplementary speakers, in response to the first time being longer than the second time; and
applying the delay to the pair of stereo frontal speakers, in response to the second time being longer than the first time,
wherein the first time and the second time include a wireless latency delay time, in response to either of the pair of frontal stereo speakers and the pair of supplementary speakers being wirelessly connected to the audio system.

5. The method of claim 1, wherein the pair of frontal stereo speakers being near the user's ears includes the user's ears being about 100 cm to 140 cm away from the pair of frontal stereo speakers.

6. The method of claim 1, wherein the generic ILD is obtained by positioning a pair of reference stereo speakers directed to the user's ears, playing test audio signals through the pair of reference stereo speakers, and measuring the ILD at the user's ears across a frequency range of about 1 khz to about 10 kHz to obtain the generic ILD.

7. The method of claim 1, wherein the generic ILD is obtained from a generic database.

8. The method of claim 1, wherein the pair of supplementary speakers are near-ear and implemented in forms selected from the group consisting of neck-worn speakers, neckband speakers, headband speakers, chair speakers, spectacle frames, and head-worn apparel such as caps, hats and beanies.

9. The method of claim 8, wherein low frequency components of audio output of the pair of supplementary speakers is removed.

10. The method of claim 9, wherein low frequency components of audio output of the pair of supplementary speakers is removed by applying a high pass filter.

11. An audio system for replicating headphone sound using a pair of frontal stereo speakers and a pair of supplementary speakers comprising:
the pair of frontal stereo speakers and the pair of supplementary speakers configured for placement near a user's ears;
a delay module configured to apply a delay to either the pair of frontal stereo speakers or the pair of supplementary speakers;
a storage module configured to store a set of pre-calibrated equalization (EQ) settings; and
an audio processing module configured to apply the set of pre-calibrated EQ settings to the pair of supplementary speakers,
wherein the set of pre-calibrated EQ settings is derived from a comparison of measured interaural level differences (ILD) of the audio system with a generic ILD and pre-calibrated to reduce differences between the measured ILD and the generic ILD.

12. The audio system of claim 11, wherein the delay is obtained by a delay measurement module configured to:
play test audio signal through the pair of frontal stereo speakers;
measure a first time taken for test audio signal to arrive at the user's ears;
play test audio signal through the pair of supplementary speakers;
measure a second time for test audio signal to arrive at the user's ears;
determine the delay by calculating a difference in the first time and the second time;
apply the delay to the pair of supplementary speakers, in response to the first time being longer than the second time; and
apply the delay to the pair of stereo frontal speakers, in response to the second time being longer than the first time.

13. The audio system of claim 11, wherein the delay is obtained by a delay calculation module configured to:
calculate a first time for sound waves to arrive at the user's ears from the pair of frontal stereo speakers;
calculate a second time for sound waves to arrive at the user's ears from the pair of supplementary speakers;
determine the delay by calculating a difference in the first time and the second time;
apply the delay to the pair of supplementary speakers, in response to the first time being longer than the second time; and
apply the delay to the pair of stereo frontal speakers, in response to the second time being longer than the first time,
wherein the first time and second time include a wireless latency delay time, in response to either of the pair of frontal stereo speakers and the pair of supplementary speakers being wirelessly connected to the audio system.

14. The audio system of claim 11, wherein the user's ears are about 100 cm to about 140 cm away from the pair of frontal stereo speakers.

15. The audio system of claim 11, wherein the generic ILD is obtained by positioning a pair of reference stereo speakers directed to the user's ears, playing test audio signals through the pair of reference stereo speakers, and measuring ILD at the user's ears position across a frequency range of about 1 khz to about 10 kHz to obtain the generic ILD.

16. The audio system of claim 15, wherein the measuring ILD at the user's ears position is carried out using a head and torso simulator or a binaural microphone.

17. The audio system of claim 11, wherein the generic ILD is obtained from a generic database.

18. The audio system of claim 11, wherein the pair of supplementary speakers are near-ear and implemented in forms selected from the group consisting of neck-worn speakers, neckband speakers, headband speakers, chair speakers, spectacle frames, and head-worn apparel such as caps, hats and beanies.

19. The audio system of claim 18, wherein low frequency components of audio output of the pair of supplementary speakers is removed.

20. The audio system of claim 19, wherein low frequency components of audio output of the pair of supplementary speakers is removed by applying a high pass filter.
